(19) United States
(12) Patent Application Publication
(10) Pub. No.: US 2015/0022189 A1
(43) Pub. Date: Jan. 22, 2015

(54) POSITION DETECTION DEVICE

(71) Applicant: ALPS ELECTRIC CO., LTD., Tokyo (JP)

(72) Inventors: Yukiko YASUDA, Tokyo (JP); Ichiro TOKUNAGA, Tokyo (JP); Eiji SHINOHARA, Tokyo (JP)

(21) Appl. No.: 14/332,554

(22) Filed: Jul. 16, 2014

(30) Foreign Application Priority Data
Jul. 16, 2013 (JP) 2013-147566

(51) Int. Cl. G01B 7/00

(52) U.S. Cl. CPC G01B 7/003
USPC 324/207.13

(57) ABSTRACT

A detection unit is disposed at a position facing a first magnet with a spacer member interposed therebetween, the first magnet is disposed between the spacer member and a second magnet so that a polarity of the first magnet corresponds to a polarity of the second magnet opposite to the polarity of the first magnet, a magnetic force generated from the second magnet reaches a position distant from the detection unit in a space to be detected as compared to a magnetic force generated from the first magnet, a magnetic field is generated by composition of the magnetic force generated from the first magnet and the magnetic force generated from the second magnet, and the detection unit detects the approach of an object to be detected by detecting a change of a magnetic field that occurs when an influence of the magnetic force generated from the second magnet is changed.

### CLAIM OF PRIORITY

This application contains subject matter related to and claims the benefit of Japanese Patent Application No. 2013-147566 filed on Jul. 16, 2013, the entire contents of which is incorporated herein by reference.

### BACKGROUND OF THE DISCLOSURE

1. Field of the Disclosure

The present Disclosure relates to a position detection device, and more particularly, to a magnetic position detection device that detects an object to be detected by a magnetic change.

2. Description of the Related Art

Conventional position detection devices, which detect the approach of an object to be detected to a predetermined position by a magnetic change are used for various purposes, such as an operation directly relating to driving of a steering wheel, an accelerator, a brake, and the like, the opening and closing of a door or a window, and the detection of the position of a seat, as the control of, for example, an automobile or the like is changed into a control using electronics. For this reason, the size of the position detection device is required to be reduced so that the position detection device can be installed at a place according to a purpose.

Japanese Unexamined Utility Model Registration Application Publication No. 62-120239 (first related art example) discloses a proximity sensor (position detection device) 900 shown in FIG. 8. A magneto-electric transducer 904 as a detection unit is, for example, a Hall element and is mounted on an upper surface of a circuit board 903. Permanent magnets 909 and 910 are fixed to the upper surface of the circuit board 903 by, for example, an adhesive so as to be positioned on both left and right sides of the magneto-electric transducer 904, and the permanent magnets 909 and 910 are positioned so that an N pole of each of the permanent magnets 909 and 910 is close to the magneto-electric transducer 904 and an S pole thereof is distant from the magneto-electric transducer 904 (an axis connecting the N pole with the S pole is parallel to a horizontal direction). The magnetic flux density of a permanent magnet 912 is lower than the magnetic flux density of each of the permanent magnets 909 and 910, and the permanent magnet 912 is fixed to the lower surface of the circuit board 903 by an adhesive so as to be positioned immediately below the magneto-electric transducer 904. The permanent magnet 912 is positioned so that an N pole of the permanent magnet 912 is close to the magneto-electric transducer 904 and an S pole thereof is distant from the magneto-electric transducer 904 (an axis connecting the N pole with the S pole is parallel to a vertical direction). The proximity sensor detects that an object to be detected approaches the magneto-electric transducer 904 as the detection unit from above and the object to be detected approaches a predetermined position.

However, in the proximity sensor 900 disclosed in Japanese Unexamined Utility Model Registration Application Publication No. 62-120239, the permanent magnets 909 and 910 are disposed on both sides of the magneto-electric transducer 904 so as to be lined up on the surface (upper surface) of the circuit board 903 where the magneto-electric transducer (detection unit) 904 is mounted. Accordingly, there has been a problem in that a projected area of the proximity sensor is large. Further, since the upper surface of the board becomes thick and a distance between the detection unit and the object to be detected cannot be smaller than the height of the magnet, there has been a problem in that a detection range is narrowed.

These and other drawbacks exist.

### SUMMARY OF THE DISCLOSURE

Embodiments of the present disclosure provide a position detection device that can make a projected area small without narrowing a detection range.

According to an example embodiment, a position detection device includes: a detection unit configured to detect the approach of an object to be detected in a space to be detected; a spacer member; and a first magnet and a second magnet configured to generate a magnetic field in the space to be detected. The detection unit is disposed at a position that faces the first magnet with the spacer member interposed therebetween, the first magnet is disposed between the spacer member and the second magnet so that a polarity of the first magnet corresponds to a polarity of the second magnet opposite to the polarity of the first magnet, a magnetic force generated from the second magnet reaches a position distant from the detection unit in the space to be detected as compared to a magnetic force generated from the first magnet, a magnetic field is generated by composition of the magnetic force that is generated from the first magnet and the magnetic force that is generated from the second magnet, and the detection unit detects the approach of the object to be detected by detecting a change of a magnetic field that occurs when an influence of the magnetic force generated from the second magnet is changed by the object to be detected moving in the space to be detected.

Since the magnets are disposed on one side of the detection unit so as to overlap with the detection unit, it is possible to make a projected area of the position detection device small. Further, since only the detection unit is present on the surface of the spacer member facing the detection unit, a distance between the detection unit and the object to be detected can be made short. Accordingly, a detection range is not narrowed. Therefore, it is possible to provide a position detection device that can make a projected area small without narrowing a detection range.

Furthermore, a length of the first magnet in a magnetization direction may be shorter than a length of the second magnet in the magnetization direction and the first and second magnets may be disposed so as to come into contact with each other.

Since the length of the first magnet in the magnetization direction is shorter than the length of the second magnet in the magnetization direction, a magnetic force generated from a portion of the second magnet, which does not overlap with the first magnet, reaches a distant position.

Moreover, the second magnet may be formed so that two magnets are connected to each other with a magnetic member interposed therebetween.

Since the second magnet is formed so that the magnetic member more inexpensive than a magnet is interposed between the two magnets, small magnets can be used. For this reason, since it is possible to make the second magnet inexpensive while maintaining the size of the second magnet, it is possible to reduce the cost of the position detection device.

### BRIEF DESCRIPTION OF THE DRAWINGS

FIG. 1 is a view showing the appearance of a position detection device according to an embodiment of the disclosure;

FIG. 2 is an exploded perspective view showing the structure of the position detection device according to an embodiment of the disclosure;

FIGS. 3A and 3B are views illustrating the structure of a position detection device according to an embodiment of the disclosure;

FIG. 4 is a cross-sectional view taken along line A-A shown in FIG. 3A;

FIGS. 5A and 5B are schematic cross-sectional views illustrating magnetic lines of force that are generated by a first magnet and a second magnet;

FIGS. 6A and 6B are views illustrating the operation of a position detection device according to an embodiment of the disclosure;

FIGS. 7A and 7B are views showing a example embodiment of the second magnet according to the disclosure; and

FIG. 8 is a view illustrating a prior art proximity sensor as disclosed in Japanese Unexamined Utility Model Registration Application Publication No. 62-120239.

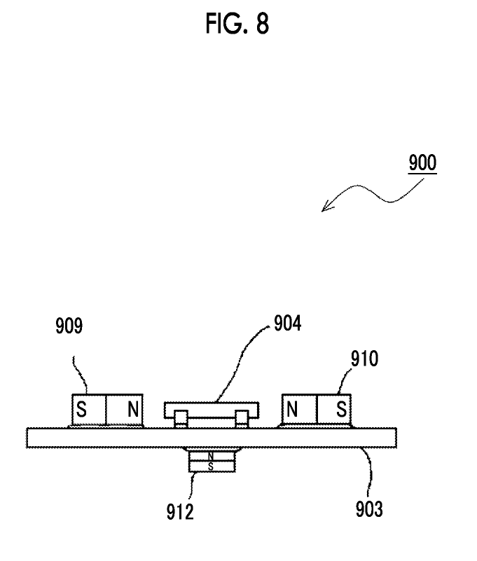

### DETAILED DESCRIPTION OF THE DISCLOSURE

The following description is intended to convey a thorough understanding of the embodiments described by providing a number of specific embodiments and details involving a position detection device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

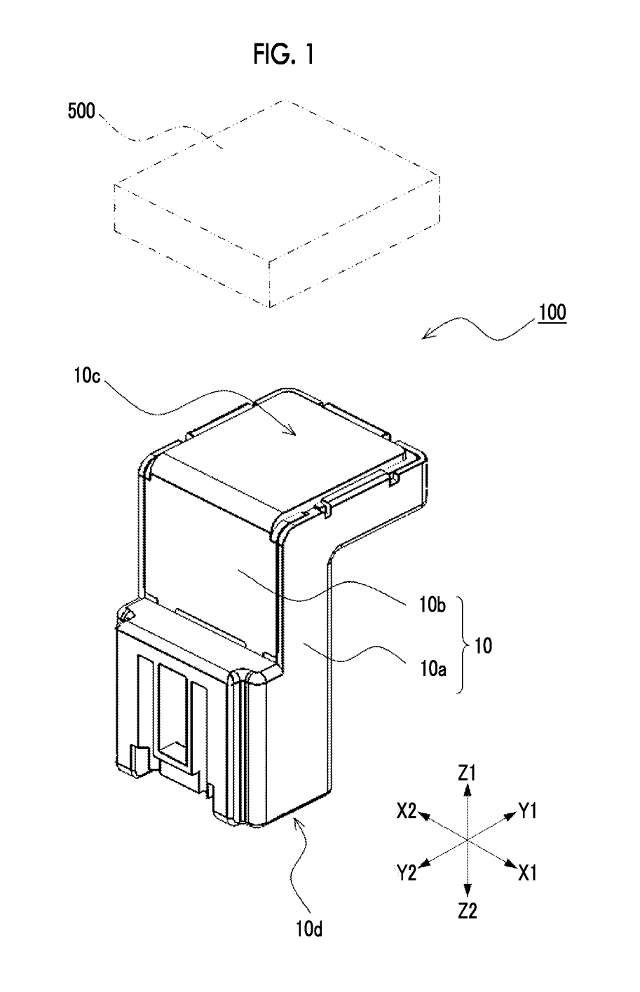

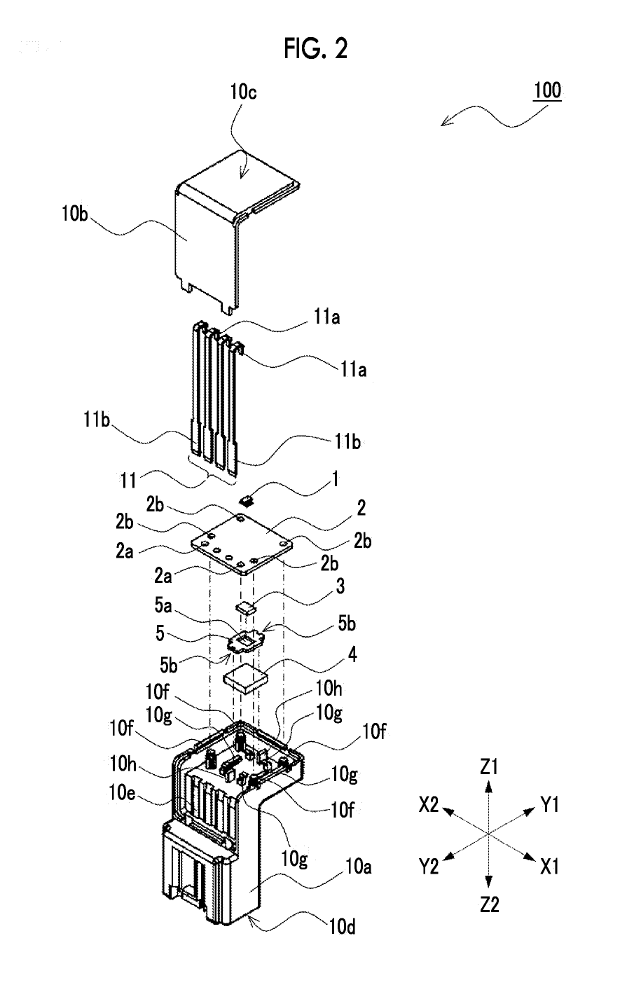

The structure of the position detection device 100 according to this embodiment will be described first with reference to FIGS. 1 and 2. FIG. 1 is a view showing the appearance of the position detection device 100. FIG. 2 is an exploded perspective view showing the structure of the position detection device 100.

As shown in FIG. 1, the position detection device 100 may have an external shape that is formed by a housing 10. The housing 10 may be made of a non-magnetic synthetic resin material, for example, and may be formed in a substantially L shape. As shown in FIG. 1, the housing 10 may include a base part 10a and a cover part 10b. The base part 10a may be provided with a connection portion 10d, and the cover part 10b may be provided with a detection surface 10c.

When the position detection device 100 is used, the position detection device 100 may be disposed so that the detection surface 10c faces a space to be detected. The position detection device 100 may detect that an object 500 to be detected moving in a space to be detected approaches the detection surface 10c. A plurality of connection electrodes 11 may be disposed in the connection portion 10d. Power, which is required for the operation of the position detection device 100, may be supplied and detection signals, which may be an output of the position detection device 100, are output through the connection electrodes 11.

As shown in FIG. 2, the position detection device 100 may include a detection unit 1, a spacer member 2, a first magnet 3, and a second magnet 4 in the housing 10, and may further include a frame 5 and the plurality of connection electrodes 11.

The detection unit 1 may be a magneto-electric transducer that uses a magnetoresistive element and the like. The detection unit 1 may convert the change of the state of a magnetic force, which may be applied to the detection unit 1, into an electric signal and outputs the electric signal.

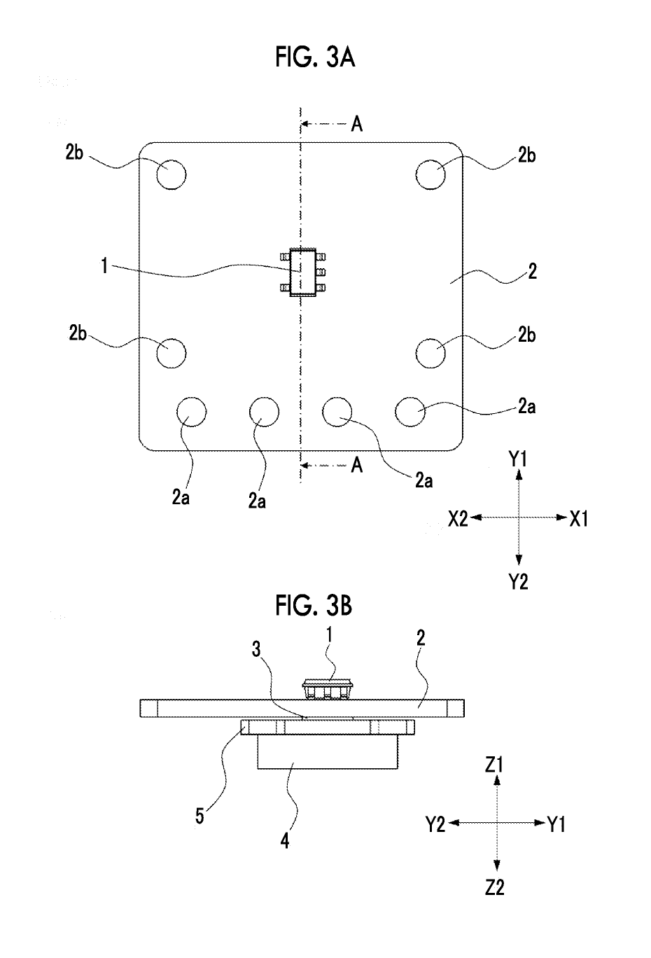

The spacer member 2 may be a printed wiring board made of glass epoxy or the like, and a copper foil pattern (not shown) may be formed on a Z1-side surface and a Z2-side surface of the spacer member 2 shown in FIG. 2. Further, four connection holes 2a and four positioning holes 2b may be formed at the spacer member 2 as shown in FIGS. 2 and 3A.

The first magnet 3 may have the shape of a rectangular plate as shown in FIG. 2, and may be magnetized in a Y1-Y2 direction shown in FIG. 2 so that a Y1 side of the first magnet 3 is an N pole and a Y2 side of the first magnet 3 is an S pole. The length of the first magnet 3 in a magnetization direction may be shorter than the length of the second magnet 4 in the magnetization direction.

The second magnet 4 may have the shape of a rectangular plate as shown in FIG. 2, and may be magnetized in the Y1-Y2 direction shown in FIG. 2 so that a Y1 side of the second magnet 4 is an S pole and a Y2 side of the second magnet 4 is an N pole. The length of the second magnet 4 in a magnetization direction may be longer than the length of the first magnet 3 in the magnetization direction.

A relationship between the shape of the first magnet 3 and the shape of the second magnet 4 and a relationship between magnetic forces applied to the first and second magnets 3 and 4 may be appropriately adjusted and set so that a desired magnetic field can be generated.

The frame 5 may be made of a non-magnetic synthetic resin material, for example. As shown in FIG. 2, the frame 5 may include a rectangular opening 5a formed at the central portion thereof and positioning portions 5b may be formed on both sides of the frame 5 (in the Y1-Y2 direction of FIG. 2).

As shown in FIG. 2, grooves 10e, which allow the connection electrodes 11 to be inserted into the connection portion 10d, may be formed in the base part 10a of the housing 10. Further, first protrusions 10f having a columnar shape may be formed at four corners on the inner bottom surface of the base part 10a that faces the detection surface 10c. Furthermore, walls 10g, which may be provided so as to surround a central portion of the bottom surface from every side, and a pair of second protrusions 10h, which may face each other from both sides of the central portion of the bottom surface, may be formed on the inner bottom surface of the base part 10a.

The connection electrode 11 may be made of a non-magnetic conductive material, such as copper or phosphor bronze. As shown in FIG. 2, a joint portion 11a may be formed at one end of the connection electrode 11 so as to be folded, and a terminal portion 11b is formed at the other end of the connection electrode 11.

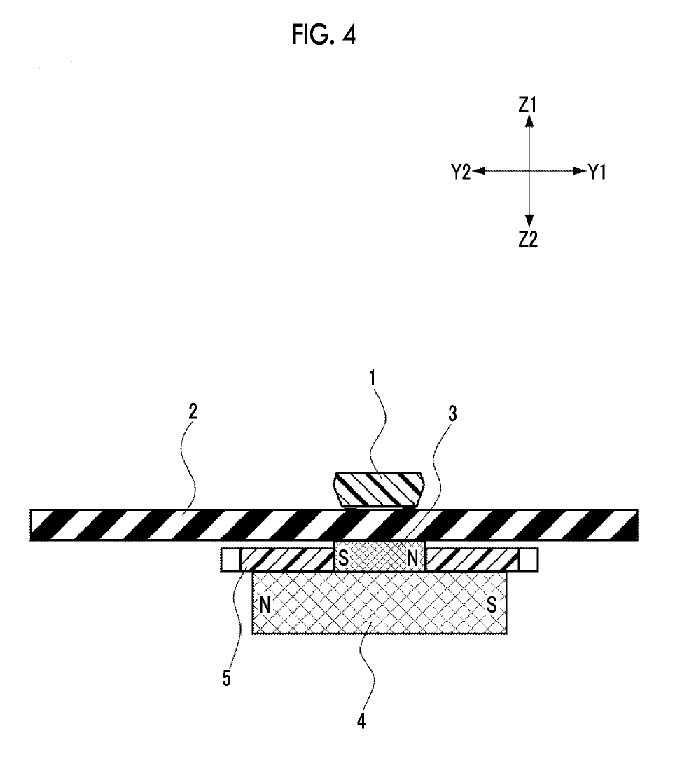

FIGS. 3A and 3B are views illustrating the structure of the position detection device 100, FIG. 3A is a top view of the spacer member 2 that is viewed from the Z1 side, and FIG. 3B is a side view of the position detection device 100 except for the housing 10 and the connection electrode 11. FIG. 4 is a cross-sectional view taken along line A-A shown in FIG. 3A.

As shown in FIGS. 2 to 3B, the detection unit 1 may be mounted on the upper surface (Z1-side surface) of the spacer member 2 and may be electrically connected to the formed copper foil pattern by soldering or the like. Further, the joint portions 11a, which are formed at the connection electrodes 11, may be inserted into the connection holes 2a formed at the spacer member 2, and are structurally fixed and electrically connected to the spacer member 2 by soldering, caulking, or the like.

The second magnet 4 may be positioned on the inner bottom surface of the base part 10a, which faces the detection surface 10c of the housing 10, by the walls 10g that are provided so as to surround the central portion of the inner bottom surface from every side. The second magnet 4 may be fixed inside the walls 10g in the Y1-Y2 direction shown in FIG. 2 so that the Y1 side of the second magnet 4 is an S pole and the Y2 side of the second magnet 4 is an N pole.

When the positioning portions 5b formed on both sides of the frame 5 (in the Y1-Y2 direction of FIG. 2) are engaged with the pair of second protrusions 10h that are formed on the inner bottom surface of the base part 10a facing the detection surface 10c of the housing 10 and face each other from both sides of the central portion, the frame 5 is positioned. The frame 5 may be fixed so as to face the upper surface (Z1-side surface) of the second magnet 4.

The first magnet 3 may be positioned by the rectangular opening 5a formed at the central portion of the frame 5. The first magnet 3 may be disposed and fixed inside the opening 5a in an X1-X2 direction shown in FIG. 2 so that the first magnet 3 comes into contact with the upper surface (Z1-side surface) of the second magnet 4 and the Y1 side of the first magnet 3 is an N pole and the Y2 side of the first magnet 3 is an S pole.

When the first protrusions 10f, which have a columnar shape and are formed at four corners on the inner bottom surface of the base part 10a facing the detection surface 10c of the housing 10, are inserted into the positioning holes 2b, the spacer member 2 is positioned. The spacer member 2 may be disposed and fixed so as to come into contact with the upper surface (Z1-side surface) of the first magnet 3. For this reason, the detection unit 1 may be disposed close to the detection surface 10c and a space to be detected may be formed above the upper side (Z1 side) of the detection unit 1. Further, the terminal portions 11b of the connection electrodes 11 may be inserted into the grooves 10e formed in the base part 10a of the housing 10, and may be fixed so as to be exposed to the inside of the connection portion 10d.

As shown in FIGS. 3B and 4, the detection unit 1 may be mounted on the upper surface (Z1-side surface) of the spacer member 2 and may be disposed at a position that faces the first magnet 3 with the spacer member 2 interposed therebetween. As shown in FIG. 4, the first magnet 3 may be disposed between the spacer member 2 and the second magnet 4 so that the polarity of the first magnet 3 corresponds to the polarity of the second magnet 4 opposite to the polarity of the first magnet 3. Since the first and second magnets 3 and 4 are disposed as described above, a magnetic field may be generated by the composition of the magnetic force generated from the first magnet 3 and the magnetic force generated from the second magnet 4 and this magnetic field may be applied to the detection unit 1.

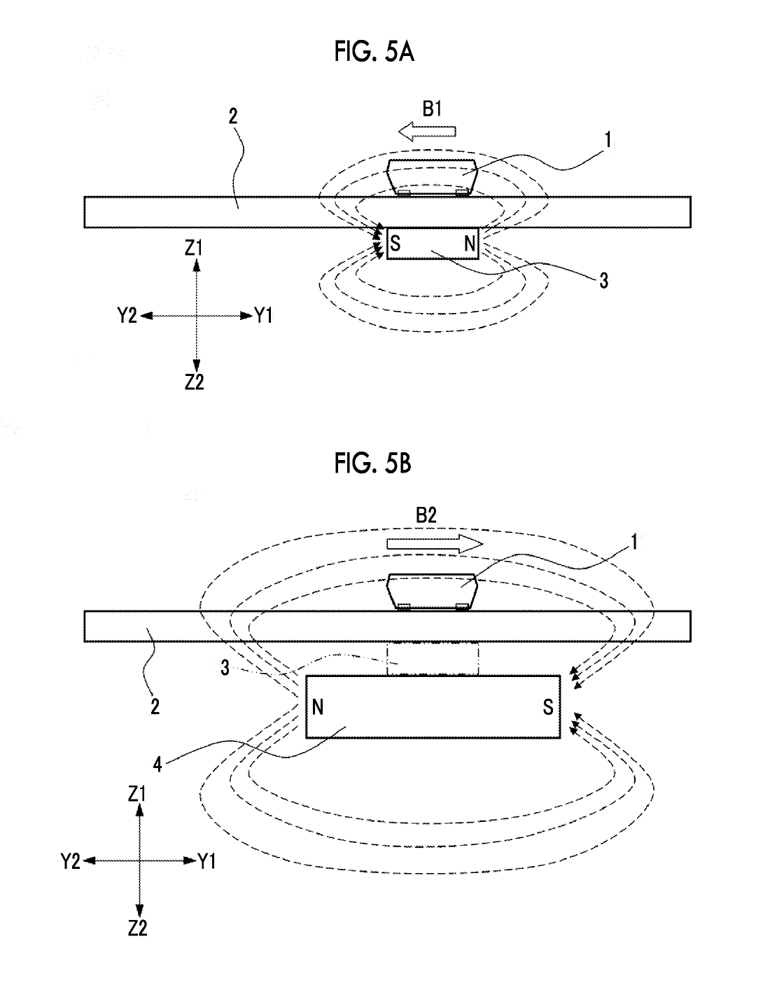

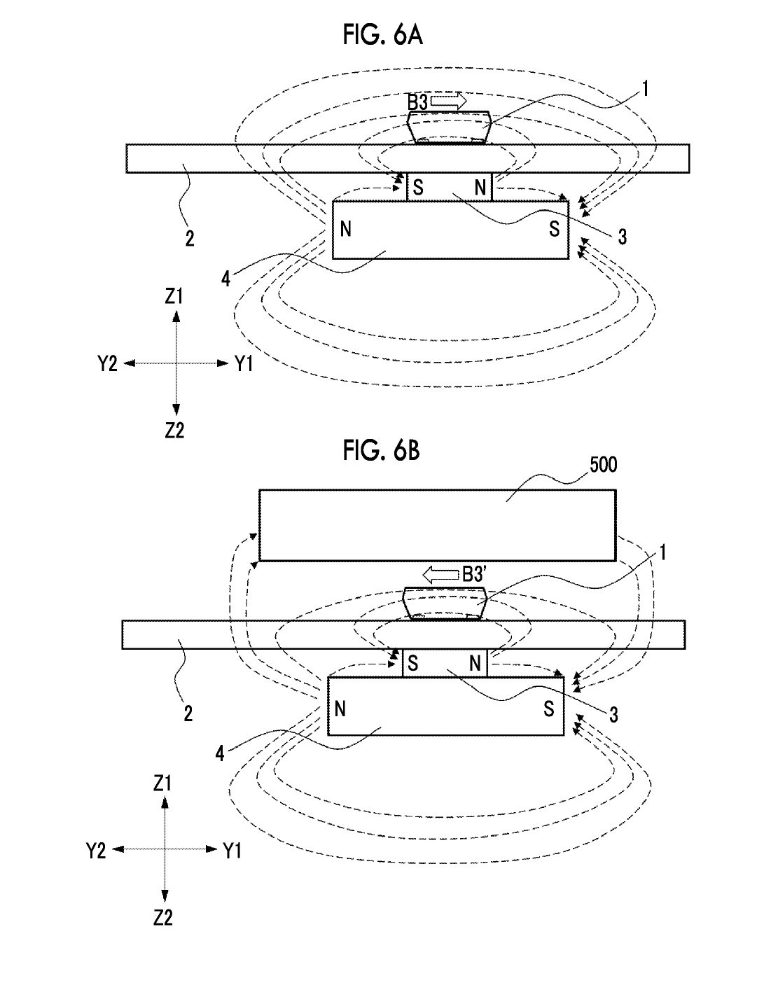

Next, the operation of the position detection device 100 will be described with reference to FIGS. 5A to 6B. FIGS. 5A and 5B are schematic cross-sectional views illustrating magnetic lines of force that are generated by the first and second magnets 3 and 4. FIG. 5A is a schematic cross-sectional view showing the state of the magnetic force that is generated by the first magnet 3, and FIG. 5B is a schematic cross-sectional view showing the state of the magnetic force that is generated by the second magnet 4. FIGS. 6A and 6B are views illustrating the operation of the position detection device 100, FIG. 6A is a schematic cross-sectional view showing the initial state of the position detection device 100, and FIG. 6B is a schematic cross-sectional view showing the state of the position detection device 100 when the object 500 to be detected approaches. Meanwhile, in FIGS. 5A to 6B, for the facilitation of description, the detection unit 1, the spacer member 2, and the first and second magnets 3 and 4 are shown as necessary and other components will be omitted.

The magnetic force, which may be generated by the first magnet 3, can be shown as in FIG. 5A by magnetic lines of force, and the magnetic lines of force are shown by broken lines that are directed to the S pole of the first magnet 3 from the N pole of the first magnet 3. In this state, a magnetic field, which is directed to the Y2 side in the Y1-Y2 direction shown in FIG. 5A and has strength B1, is applied to the detection unit 1 by the magnetic force that is generated by the first magnet 3.

The magnetic force, which may be generated by the second magnet 4, can be shown as in FIG. 5B by magnetic lines of force, and the magnetic lines of force are shown by broken lines that are directed to the S pole of the second magnet 4 from the N pole of the second magnet 4. In this state, a magnetic field, which is directed to the Y1 side in the Y1-Y2 direction shown in FIG. 5B and has strength B2, may be applied to the detection unit 1 by the magnetic force that is generated by the second magnet 4. Further, the magnetic force generated from the second magnet 4 may reach a position distant from the detection unit 1 in the space to be detected, which is formed above the upper side (Z1 side) of the detection unit 1, as compared to the magnetic force generated from the first magnet 3.

Accordingly, the magnetic forces applied to the detection unit 1 can be shown as in FIG. 6A by magnetic lines of force. In this state, a magnetic field, which is directed to the Y1 side in the Y1-Y2 direction shown in FIG. 6A and has strength B3 (=B2−B1), may be applied to the detection unit 1 by the composition of the magnetic force that is generated from the first magnet 3 and the magnetic force that is generated from the second magnet 4. This state is a state (initial state) in which the object 500 to be detected does not approach the space to be detected by the position detection device 100.

When the object 500 to be detected, which is formed of a magnetic body, moves and approaches the space to be detected, the magnetic force, which is generated from the second magnet 4 and reaches a position distant from the detection unit 1 as compared to the magnetic force generated from the first magnet 3, may be transmitted through the object 500 that is to be detected and has high magnetic permeability, as shown in FIG. 6B.

For this reason, since the magnetic force (B2) generated from the second magnet 4 is reduced, the direction of the magnetic force, which is obtained by the composition of the magnetic force generated from the first magnet 3 and the magnetic force generated from the second magnet 4, may be reversed from the initial state. As a result, the magnetic force applied to the detection unit 1 may be directed to the Y2 side in the Y1-Y2 direction. Further, the strength of the magnetic field becomes B3′ (=B1−B2).

The influence of the magnetic force, which is generated from the second magnet 4, on the detection unit 1 is changed by the approach of the object 500 to be detected that is formed of a magnetic body, and the detection unit 1 may detect the change of the direction of the magnetic field applied to the detection unit 1, converts the change of the direction of the magnetic field into an electric signal, and outputs the electric signal. Accordingly, the detection unit 1 can detect the approach of the object 500 to be detected.

Since the first and second magnets 3 and 4 are disposed below the detection unit 1 (Z2 side of the detection unit 1) so as to overlap with the detection unit 1, it is possible to detect the approach of the object 500 to be detected even though the object 500 to be detected approaches in the X1-X2 direction, approaches in the Y1-Y2 direction, or approaches in the Z1 direction.

When the object 500 to be detected, which is formed of a magnetic body, moves and becomes distant from the space to be detected, the position detection device 100 may return to the initial state shown in FIG. 6A and the magnetic force applied to the detection unit 1 may be directed to the Y1 side in the Y1-Y2 direction again.

The influence of the magnetic force, which is generated from the second magnet 4, on the detection unit 1 may be changed when the object 500 to be detected formed of a magnetic body becomes distant from the detection unit 1, and the detection unit 1 detects the change of the direction of the magnetic field applied to the detection unit 1, converts the change of the direction of the magnetic field into an electric signal, and outputs the electric signal. Accordingly, the detection unit 1 can detect that the object 500 to be detected becomes distant.

In the position detection device 100 according to this embodiment, the detection unit 1 may be disposed at a position that faces the first magnet 3 with the spacer member 2 interposed therebetween; the first magnet 3 may be disposed between the spacer member 2 and the second magnet 4 so that the polarity of the first magnet 3 corresponds to the polarity of the second magnet 4 opposite to the polarity of the first magnet 3; the magnetic force generated from the second magnet 4 may reach a position, which is distant from the detection unit 1 in the space to be detected as compared to the magnetic force generated from the first magnet 3; the magnetic field, which is obtained by the composition of the magnetic force generated from the first magnet 3 and the magnetic force generated from the second magnet 4, may be changed by the approach of the object 500 to be detected moving in the space to be detected; and the object 500 to be detected is detected from the change of the magnetic field.

For this reason, since the first and second magnets 3 and 4 are disposed on one side of the detection unit 1 so as to overlap with the detection unit 1, a projected area of the position detection device can be made small. Further, since only the detection unit 1 is present on the surface of the spacer member 2 facing the detection unit 1, a distance between the detection unit 1 and the object 500 to be detected can be made short. Accordingly, a detection range is not narrowed. Therefore, it is possible to provide a position detection device that can make a projected area small without narrowing a detection range.

Furthermore, in the position detection device 100 according to this embodiment, the length of the first magnet 3 in the magnetization direction may be shorter than the length of the second magnet 4 in the magnetization direction and the first and second magnets 3 and 4 may be disposed so as to come into contact with each other.

Accordingly, since the length of the first magnet 3 in the magnetization direction is shorter than the length of the second magnet 4 in the magnetization direction, a magnetic force generated from a portion of the second magnet 4, which does not overlap with the first magnet 3, reaches a distant position.

According to the position detection device 100 of this embodiment, it is possible to provide a position detection device that can make a projected area small without narrowing a detection range as described above.

The position detection device 100 according to the embodiment of the invention has been specifically described as described above, but the invention is not limited to the embodiment and may be variously modified without departing from the gist. For example, the invention may have the following modifications, and these modifications are also included in the scope of the invention.

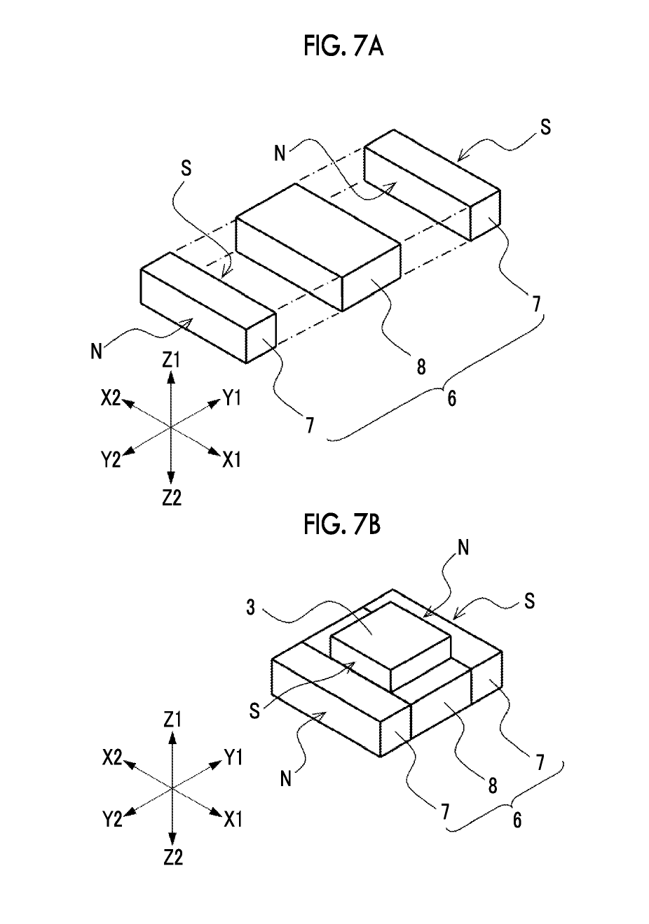

(1) An example in which the second magnet is formed of one magnet having the shape of a rectangular plate has been described in this embodiment. However, as shown in FIGS. 7A and 7B, a second magnet 6 may be formed so that two magnets 7 are connected to each other with a magnetic member 8 interposed therebetween. FIGS. 7A and 7B are views showing the structure of the second magnet 6, FIG. 7A is an exploded perspective view showing the structure of the second magnet 6, and FIG. 7B is a view showing a state in which the second magnet 6 and the first magnet 3 are assembled with each other. When the second magnet 6 has this structure, the second magnet can be formed so that the magnetic member 8 more inexpensive than a magnet is interposed between the two magnets 7. Accordingly, small magnets can be used as the two magnets 7. For this reason, since it is possible to make the second magnet inexpensive while maintaining the size of the second magnet, it is possible to reduce the cost of the position detection device.

(2) An example in which the position detection device 100 includes the housing 10 has been described in this embodiment. However, the housing may be omitted according to the use of the position detection device 100. Further, the shape of the housing may also be appropriately modified according to the use of the position detection device 100 or a place in which the position detection device 100 is to be installed.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A position detection device comprising:
a detection unit that detects the approach of an object to be detected in a space to be detected;
a spacer member; and
a first magnet and a second magnet that generate a magnetic field in the space to be detected,
wherein the detection unit is disposed at a position that faces the first magnet with the spacer member interposed therebetween,
the first magnet is disposed between the spacer member and the second magnet so that a polarity of the first magnet corresponds to a polarity of the second magnet opposite to the polarity of the first magnet,
a magnetic force generated from the second magnet reaches a position distant from the detection unit in the space to be detected as compared to a magnetic force generated from the first magnet,
a magnetic field is generated by composition of the magnetic force that is generated from the first magnet and the magnetic force that is generated from the second magnet, and
the detection unit detects the approach of the object to be detected by detecting a change of a magnetic field that occurs when an influence of the magnetic force generated from the second magnet is changed by the object to be detected moving in the space to be detected.

2. The position detection device according to claim 1,
wherein a length of the first magnet in a magnetization direction is shorter than a length of the second magnet in the magnetization direction, and
the first and second magnets are disposed so as to come into contact with each other.

3. The position detection device according to claim 1,
wherein the second magnet is formed so that two magnets are connected to each other with a magnetic member interposed therebetween.

4. The position detection device according to claim 2,
wherein the second magnet is formed so that two magnets are connected to each other with a magnetic member interposed therebetween.
